(19) United States
(12) Patent Application Publication
(10) Pub. No.: US 2013/0113136 A1
(43) Pub. Date: May 9, 2013

(54) IMPRINT APPARATUS AND METHOD OF MANUFACTURING ARTICLE

(71) Applicant: CANON KABUSHIKI KAISHA, Tokyo (JP)

(72) Inventor: Tsuyoshi Arai, Utsunomiya-shi (JP)

(73) Assignee: CANON KABUSHIKI KAISHA, Tokyo (JP)

(21) Appl. No.: 13/648,297

(22) Filed: Oct. 10, 2012

(30) Foreign Application Priority Data
Nov. 4, 2011 (JP) 2011-242809

(51) Int. Cl. B29C 59/02

(52) U.S. Cl. 264/293; 425/385

(57) ABSTRACT

The present invention provides an imprint apparatus which performs an imprint process, the apparatus including a holding unit configured to hold a mold, a stage configured to hold a substrate, and a control unit configured to control the imprint process, wherein in the imprint process for an outer peripheral shot region among shot regions on the substrate, the control unit controls at least one of the holding unit and the stage to relatively rotate the mold and the substrate so that an outermost portion, in a radial direction of the substrate, of the imprint material supplied to the outer peripheral shot region at least partially separates from the mold last.

### BACKGROUND OF THE INVENTION

1. Field of the Invention

The present invention relates to an imprint apparatus and a method of manufacturing an article.

2. Description of the Related Art

In the imprint technology, a pattern is transferred (formed) onto a substrate such as a silicon wafer or a glass plate using, as an original, a mold having a fine pattern (a three-dimensional pattern).

An imprint apparatus which uses the imprint technology supplies a resin (imprint material) onto a substrate, brings a mold into contact with the resin, and cures the resin in this state. The imprint apparatus then releases the mold from (peels it off) the cured resin to transfer the pattern of the mold onto the substrate. At this time, a force acting on the mold upon release must be reduced to prevent any defect of the pattern (resin pattern) transferred onto the substrate. Hence, Japanese Patent Laid-Open No. 2008-183731 proposes a technique of tilting the mold in releasing it from the resin, thereby reducing a force acting on the mold upon release.

In general, circuit layers formed in previous steps and films in a manufacturing process, for example, are present in a target shot region (that is, a shot region to undergo an imprint process next) on a substrate. An imprint apparatus performs an imprint process for shot regions including the outer perimeter of the substrate (shot regions each having an area smaller than that of the pattern surface of a mold) as well, and these shot regions include the end portions of the above-mentioned circuit layers and films. The end portions of the circuit layers and films as described above have a relatively weak adhesion strength to the substrate, so the circuit layers, films, or resin may peel off the substrate upon release of the mold in shot regions including the outer perimeter of the substrate. Also, the cured resin on shot regions including the outer perimeter of the substrate may be pulled by the mold to make the substrate float from the chuck, thus making it impossible to normally release the mold.

### SUMMARY OF THE INVENTION

The present invention provides a technique advantageous in releasing a mold from an imprint material on a substrate.

According to one aspect of the present invention, there is provided an imprint apparatus which performs an imprint process in which an imprint material on a substrate is molded using a mold and cured, and the cured imprint material and the mold are separated from each other, thereby transferring a pattern onto the substrate, the apparatus including a holding unit configured to hold the mold, a stage configured to hold the substrate, and a control unit configured to control the imprint process, wherein in the imprint process for an outer peripheral shot region among shot regions on the substrate, the control unit controls at least one of the holding unit and the stage to relatively rotate the mold and the substrate so that an outermost portion, in a radial direction of the substrate, of the imprint material supplied to the outer peripheral shot region at least partially separates from the mold last.

Further features of the present invention will become apparent from the following description of exemplary embodiments with reference to the attached drawings.

### BRIEF DESCRIPTION OF THE DRAWINGS

FIG. 1 is a view showing the configuration of an imprint apparatus according to an aspect of the present invention.

FIGS. 2A to 2D are views showing the layouts of shot regions on a substrate, and a cross-section of an outer peripheral shot region.

FIGS. 3A to 3C are views for explaining an imprint process for the outer peripheral shot region according to the related art technique.

FIGS. 4A to 4C are views for explaining an imprint process for the outer peripheral shot region according to an embodiment of the present invention.

FIGS. 5A to 5C are views for explaining details of the direction in which a mold is tilted.

FIGS. 6A to 6E are views illustrating examples of the rotation center and rotation axis of the mold when the mold is released from a resin on the outer peripheral shot region.

FIGS. 7A to 7C are views for explaining an imprint process for the outer peripheral shot region according to the embodiment of the present invention.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

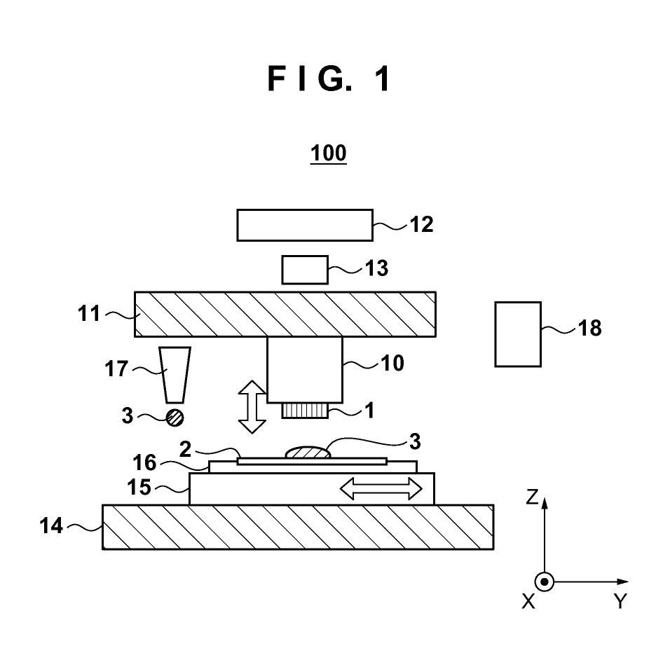

FIG. 1 is a view showing the configuration of an imprint apparatus 100 according to an aspect of the present invention. The imprint apparatus 100 performs an imprint process in which an imprint material on a substrate is molded using a mold and cured, and the mold is released from the cured imprint material, thereby transferring a pattern onto the substrate. In this embodiment, the imprint apparatus 100 uses a mold 1 and an ultraviolet-curing resin 3 as an imprint material.

The imprint apparatus 100 includes a mold head 10, structure 11, ultraviolet light source 12, illumination optical system 13, stage base 14, stage 15, resin supply unit 17, and control unit 18.

The mold head 10 is a holding unit which is attached to the structure 11 and moves upon holding the mold 1. The mold head 10 includes a mold chuck which chucks the mold 1 by vacuum attraction or electrostatic attraction, and a moving mechanism for moving the mold 1. The mold head 10 has a function of pressing the mold 1 against (bringing it into contact with) the uncured resin 3 on a substrate 2, and releasing the mold 1 from (peeling it off) the cured resin 3 on the substrate 2.

The ultraviolet light source 12 and illumination optical system 13 constitute an irradiation apparatus which irradiates the resin 3 on the substrate 2 with ultraviolet rays to cure the resin 3. However, when a thermosetting resin is used as an imprint material, the ultraviolet light source 12 and illumination optical system 13 are replaced with a heating apparatus which heats the thermosetting resin. Although the resin 3 is cured by irradiation with ultraviolet rays from the ultraviolet light source 12 in this case, the wavelength of light emitted by a light source can be determined in accordance with the type of resin 3.

The stage 15 which moves upon holding the substrate 2 is placed on the stage base 14. The stage 15 includes a substrate chuck 16 which chucks the substrate 2 by vacuum attraction, and a moving mechanism for moving the substrate 2.

The resin supply unit 17 is implemented by a dispenser head including nozzles which discharge the resin 3, and supplies the resin 3 onto the substrate 2. By movement (scan movement or step movement) of the stage 15 while the resin 3 is supplied from the resin supply unit 17, the resin 3 can be applied onto the substrate 2 (each shot region defined on it).

The control unit 18 includes, for example, a CPU and memory and controls the operation (imprint process) of the imprint apparatus 100. In other words, the control unit 18 systematically controls each unit of the imprint apparatus 100 to perform an imprint process. More specifically, the control unit 18 moves the mold head 10 to cure the resin 3 by irradiation with ultraviolet rays from the ultraviolet light source 12 and illumination optical system 13 while the mold 1 is kept pressed against the resin 3 on the substrate 2 (while the mold 1 is kept in contact with the resin 3). The control unit 18 then moves the mold head 10 to release the mold 1 from the cured resin 3 on the substrate 2, thereby transferring the pattern of the mold 1 onto the substrate 2.

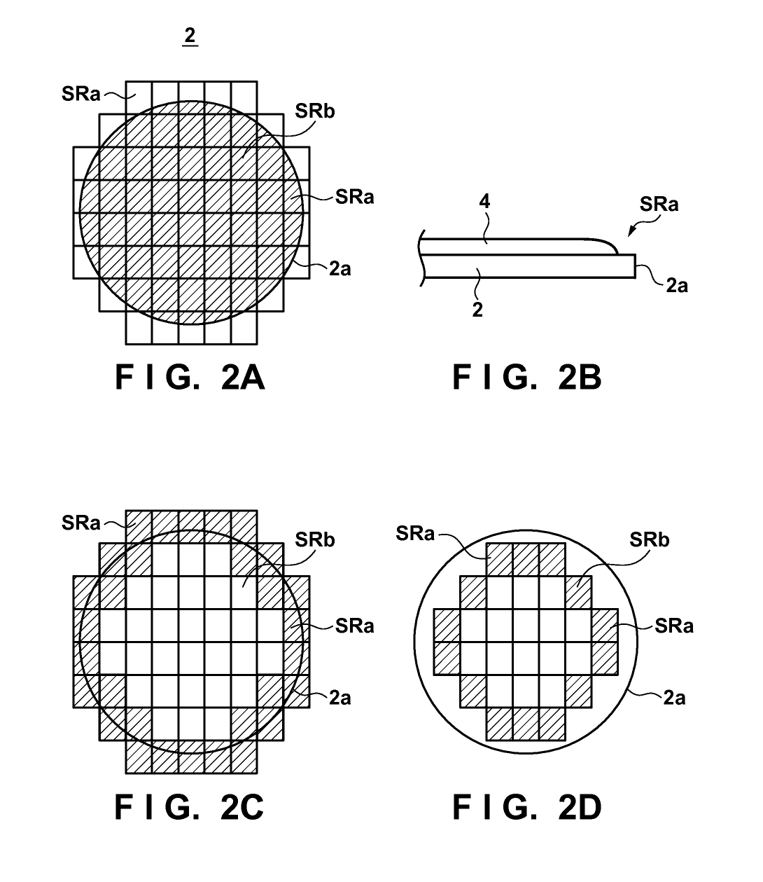

FIG. 2A is a view showing the layout of shot regions on the substrate 2. In this embodiment, to maximize the effective area of the substrate 2 (the area of a region to which the pattern of the mold 1 is transferred), the control unit 18 performs an imprint process not only in inner shot regions SRb on the substrate 2 but also in outer peripheral shot regions SRa including an outer perimeter 2a of the substrate 2. However, in this embodiment, even when a specific shot region does not include the outer perimeter 2a of the substrate 2, it is defined as an outer peripheral shot region SRa as long as it is located outermost in the radial direction of the substrate 2. For example, the outer peripheral shot regions SRa include, for example, shot regions close to the outer perimeter 2a of the substrate 2, although the entire pattern surface of the mold 1 falls within the plane of the substrate 2.

For example, shot regions including the outer perimeter 2a may be defined as the outer peripheral shot regions SRa, as indicated by hatched portions in FIG. 2C. Also, shot regions which do not include the outer perimeter 2a but are located outermost in the radial direction of the substrate 2 may be defined as the outer peripheral shot regions SRa, as indicated by hatched portions in FIG. 2D. Moreover, shot regions including the shot regions shown in both FIGS. 2C and 2D may be defined as outer peripheral shot regions.

FIG. 2B is a sectional view showing a cross-section of the outer peripheral shot region SRa shown in FIG. 2A. An under layer 4 including circuit layers formed in previous steps and films in a manufacturing process is present on the substrate 2, and has an end portion near the outer perimeter 2a of the substrate 2, that is, within the outer peripheral shot region SRa, as shown in FIG. 2B.

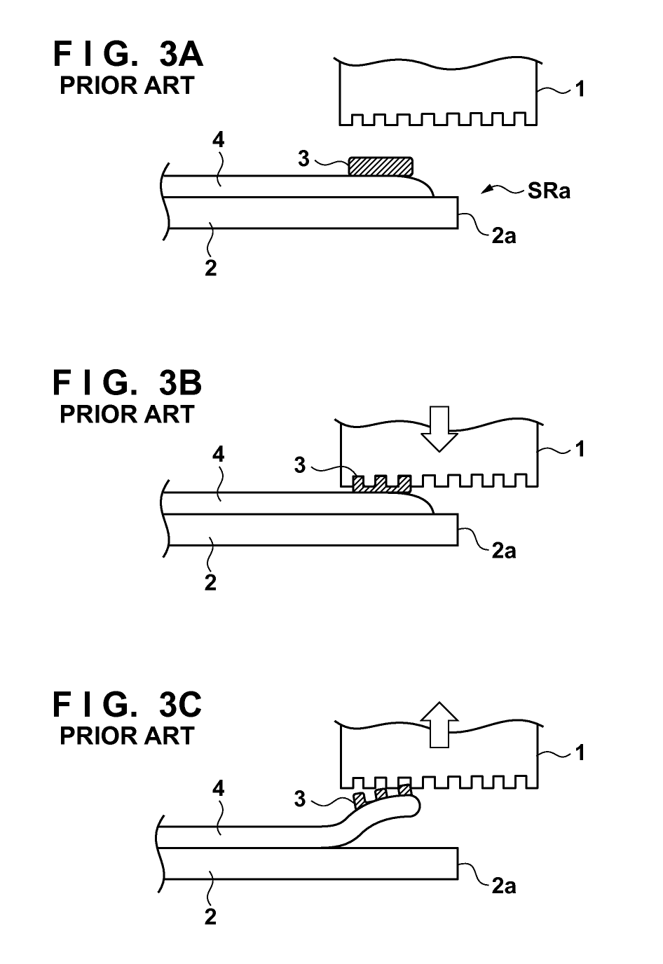

An imprint process for the outer peripheral shot region SRa according to the related art technique will be described herein with reference to FIGS. 3A to 3C. First, the resin 3 is supplied to the outer peripheral shot region SRa, and the substrate 2 is positioned so that the outer peripheral shot region SRa is set below the mold 1 (at the imprint position of the mold 1), as shown in FIG. 3A. Then, the mold 1 is pressed against the resin 3 on the outer peripheral shot region SRa, and the resin 3 is cured by irradiation with ultraviolet rays while the mold 1 is kept in contact with the resin 3, as shown in FIG. 3B. Lastly, the mold 1 is released from the cured resin 3 on the outer peripheral shot region SRa. At this time, when the mold 1 moves in the Z-direction (vertical direction), the under layer 4 may peel off the substrate 2 due to concentration of a force, produced upon release of the mold 1, on the end portion of the under layer 4, as shown in FIG. 3C. This makes it impossible to transfer the pattern of the mold 1 to the outer peripheral shot region SRa. In addition, as the substrate chuck 16 chucks the substrate 2 by vacuum attraction, the substrate 2 (its end portion) floats from the substrate chuck 16 if the force produced upon release of the mold 1 exceeds the attraction force of the substrate chuck 16, so it may become impossible to normally release the mold 1.

To combat this problem, in this embodiment, in an imprint process for the outer peripheral shot region SRa, the control unit 18 controls release of the mold 1 so as to prevent the under layer 4 from peeling off the substrate 2 and the substrate 2 from floating from the substrate chuck 16. The control unit 18 controls at least one of the mold head 10 and the stage 15 so that a portion from which the mold 1 is released last from the resin 3 becomes at least part of the outermost portion, in the radial direction of the substrate 2, of the resin 3 supplied to the outer peripheral shot region SRa.

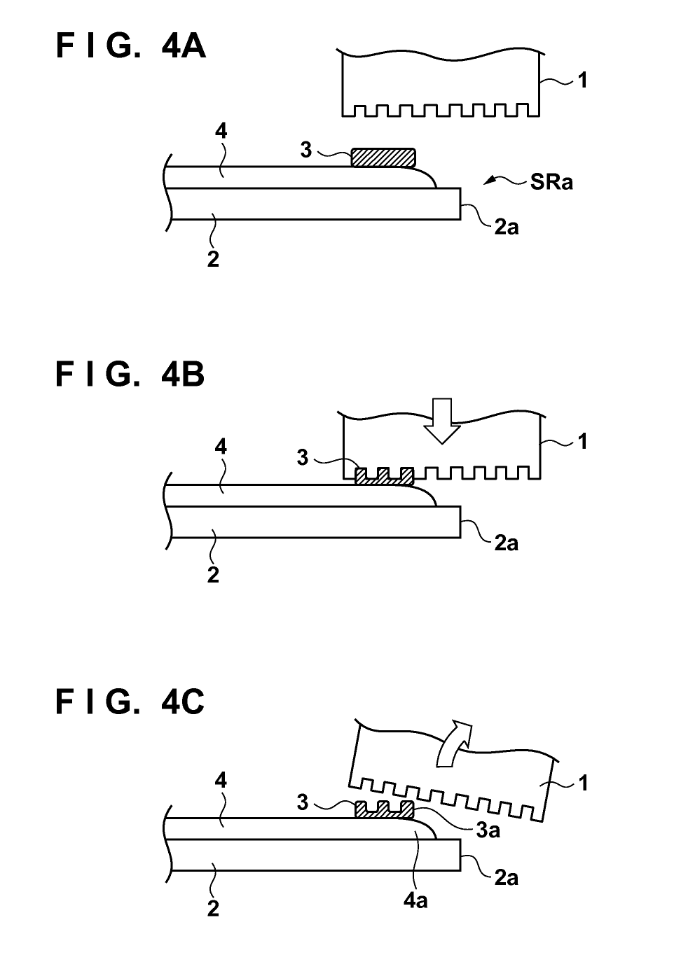

An imprint process for the outer peripheral shot region SRa according to this embodiment will be described in detail with reference to FIGS. 4A to 4C. First, the resin 3 is supplied to the outer peripheral shot region SRa, and the substrate 2 is positioned so that the outer peripheral shot region SRa is set below the mold 1, as shown in FIG. 4A. Then, the mold 1 is brought into contact with the resin 3 on the outer peripheral shot region SRa, and the resin 3 is cured by irradiation with ultraviolet rays while the mold 1 is kept in contact with the resin 3, as shown in FIG. 4B. Lastly, the mold 1 is released from the cured resin 3 on the outer peripheral shot region SRa. At this time, the mold 1 is released from the resin 3 while being tilted relative to the surface of the substrate 2 (the attraction surface of the substrate chuck 16), that is, the Z-direction (vertical direction) through the mold head 10, as shown in FIG. 4C.

In the release operation of the mold 1, as shown in FIG. 4C, the release operation between the resin 3 and the mold 1 is started from the inner region of the substrate 2 on the central side toward the outer region of the substrate 2 on the outer peripheral side (that is, from the inner side to the outer side of the substrate 2), in the outer peripheral shot region SRa. In other words, a force produced upon release of the mold 1 is transmitted from the inner region to the outer region of the substrate 2. The mold 1 is released last from a portion (the outermost portion in the radial direction of the substrate 2) 3a of the resin 3, which is located on an end portion 4a of the under layer 4, and the release operation of the mold 1 thus ends.

With this operation, in releasing the mold 1 from the resin 3 on the outer peripheral shot region SRa, the area at which the mold 1 is kept in contact (tight contact) with the resin 3 can be reduced, so a force acting on the under layer 4 and substrate 2 upon release of the mold 1 can also be reduced. It is therefore possible to prevent the under layer 4 from peeling off the substrate 2 and the substrate 2 from floating from the substrate chuck 16 in an imprint process for the outer peripheral shot region SRa. This, in turn, makes it possible to normally release the mold 1, so the pattern of the mold 1 is transferred to the outer peripheral shot region SRa.

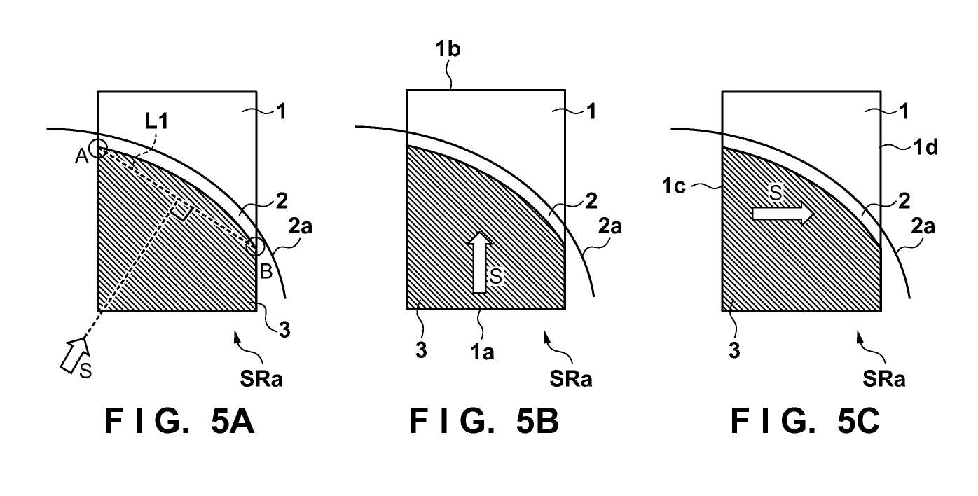

The direction in which the mold 1 is tilted in an imprint process for the outer peripheral shot region SRa will be described in detail with reference to FIGS. 5A to 5C. FIGS. 5A to 5C each show the positional relationship between the mold 1 and the outer peripheral shot region SRa, and the supply region of the resin 3 on the outer peripheral shot region SRa is indicated by a hatched portion. Because the area of the mold 1 (its pattern surface) is larger than that of the outer peripheral shot region SRa, an imprint process is performed while the mold 1 partially falls outside the outer peripheral shot region SRa. Note that the resin 3 is generally supplied to a point in the outer peripheral shot region SRa inside the outer perimeter 2a of the substrate 2 by several millimeters.

Referring, for example, to FIG. 5A, the mold 1 is tilted in releasing it in the radial direction of the substrate 2 from the center of the substrate 2, as indicated by an arrow S. More specifically, the mold 1 is released from the resin 3 while being tilted in a direction perpendicular to a line L1 which connects endpoints A and B of the arcuated resin 3 along the outer perimeter 2a of the substrate 2 to each other.

Also, referring to FIG. 5B, the mold 1 may be tilted in releasing it from one short side 1a to the other short side 1b of its plane (its pattern surface), as indicated by an arrow S. Similarly, as shown in FIG. 5C, the mold 1 may be tilted in releasing it from one long side 1c to the other long side 1d of its plane (its pattern surface), as indicated by an arrow S. Moreover, the mold 1 may be tilted in a direction along a line which connects the center of the substrate 2 to the center of the mold 1.

However, the direction in which the mold 1 is tilted in releasing it from the resin 3 on the outer peripheral shot region SRa need not be limited to one specific direction, and the mold release need not always progress from the inner region to the outer region of the substrate 2, either. A portion from which the mold 1 is released last from the resin 3 on the outer peripheral shot region SRa need only at least partially include the outermost portion, in the radial direction of the substrate 2, of the resin 3.

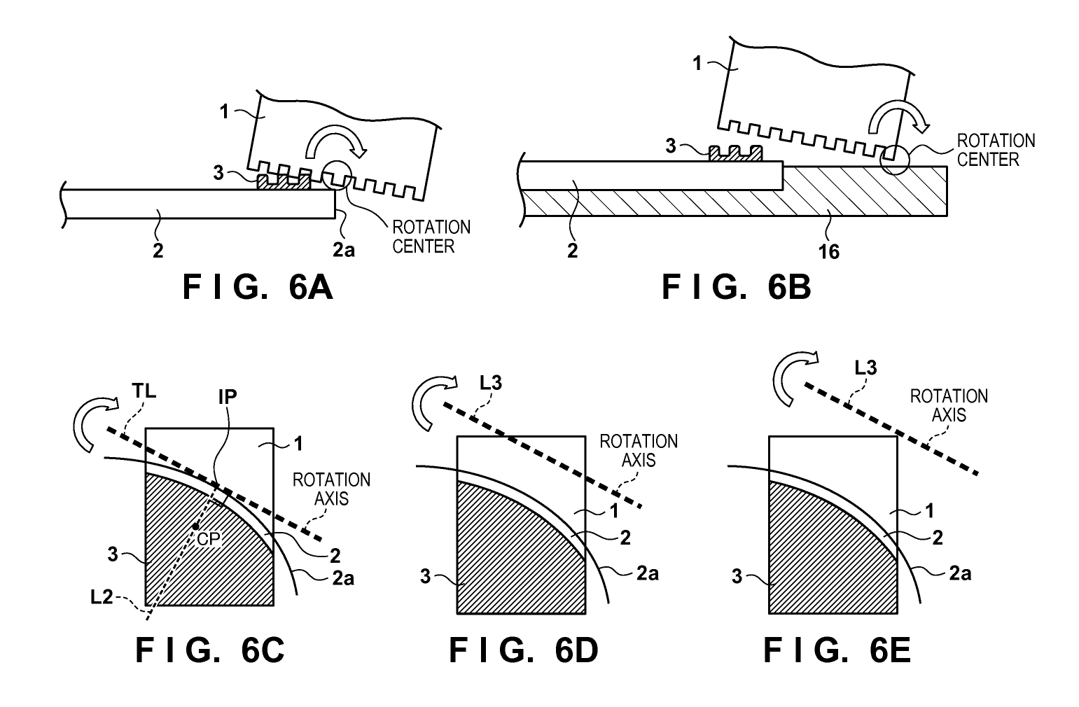

FIGS. 6A to 6E are views illustrating examples of the rotation center and rotation axis of the mold 1 when the mold 1 is released from the resin 3 on the outer peripheral shot region SRa in an imprint process for the outer peripheral shot region SRa. FIGS. 6A and 6C show the case wherein the mold 1 is tilted about a rotation axis defined by a tangent to the outer perimeter 2a of the substrate 2. More specifically, the mold head 10 is tilted to rotate the mold 1 about a rotation axis defined by an axis located on a tangent TL to the outer perimeter 2a of the substrate 2 at an intersection IP between the outer perimeter 2a of the substrate 2 and a line L2 which connects the center of the substrate 2 to the center CP of the outer peripheral shot region SRa. Note that the rotation axis of the mold 1 may be set on the pattern surface of the mold 1 or in the outer peripheral shot region SRa on the substrate 2. Also, when the position of the rotation axis on the substrate plane is set on the inner side of the substrate 2 with respect to the position of the rotation axis shown in each of FIGS. 6A and 6C, the mold 1 and the substrate 2 interfere with each other upon tilting and releasing the mold 1. It is therefore desired to set the rotation axis on the outer side of the substrate 2 with respect to the tangent to the substrate 2, as shown in FIGS. 6B, 6D, and 6E. An axis located at a distance larger than the radius of the substrate 2 is set as a rotation axis. For example, the mold head 10 is desirably tilted to rotate the mold 1 about a rotation axis defined by an axis located on a line L3 obtained by translating the tangent TL shown in FIG. 6C in the radial direction of the substrate 2 from the center of the substrate 2.

Also, the level of the substrate chuck 16 is often almost the same as that of the surface of the substrate 2, as shown in FIG. 6B. In such a case, the mold head 10 is desirably tilted to rotate the mold 1 about a rotation center defined by the outermost peripheral position of the pattern surface of the mold 1 or a position outside it, as shown in FIG. 6E. This structure is not limited to the substrate chuck 16, and can be replaced with a structure including various marks and sensors to be placed on the stage 15.

However, in releasing the mold 1 from the resin 3 on the outer peripheral shot region SRa, the mold 1 may be deformed by an actuator or a fluid pressure to curve the contact surface with the resin 3, that is, the pattern surface, instead of tilting the mold 1. The pattern surface of the mold 1 can be curved (deformed) by, for example, forming a cavity (enclosed space) between the mold 1 and the mold chuck so as to supply and exhaust air to and from the cavity through a pipe. In such a case as well, a portion from which the mold 1 is released last from the resin 3 on the outer peripheral shot region SRa need only become at least part of the outermost portion, in the radial direction of the substrate 2, of the resin 3.

The above-mentioned control of the mold 1 in releasing it may be performed upon computation in generating an imprint recipe according to which an imprint process is performed and be stored in the imprint apparatus 100, or may be performed upon computation for each of imprint processes or release operations. Alternatively, a sensor which detects the balance of a reaction force produced by the substrate 2 upon pressing of the mold 1 against the resin 3 may be placed on, for example, the mold chuck to perform the control of the mold 1 upon computation based on the detection result obtained by the sensor.

The mold 1 need not be released while the mold 1 and the substrate 2 are tilted relative to each other for all shot regions on the substrate 2. The mold 1 can be released without tilting the mold 1 and the substrate 2 relative to each other (that is, so that the mold 1 and the substrate 2 are kept parallel to each other) for, for example, the inner shot regions SRb of the substrate 2 (see FIG. 2A).

The imprint apparatus 100 according to this embodiment can prevent the under layer 4 present near the outer perimeter 2a of the substrate 2 from peeling off the substrate 2 and the substrate 2 from floating from the substrate chuck 16 upon release of the mold 1. Hence, the imprint apparatus 100 can perform a satisfactory imprint process not only for the inner shot regions SRb of the substrate 2 but also for the outer peripheral shot regions SRa of the substrate 2.

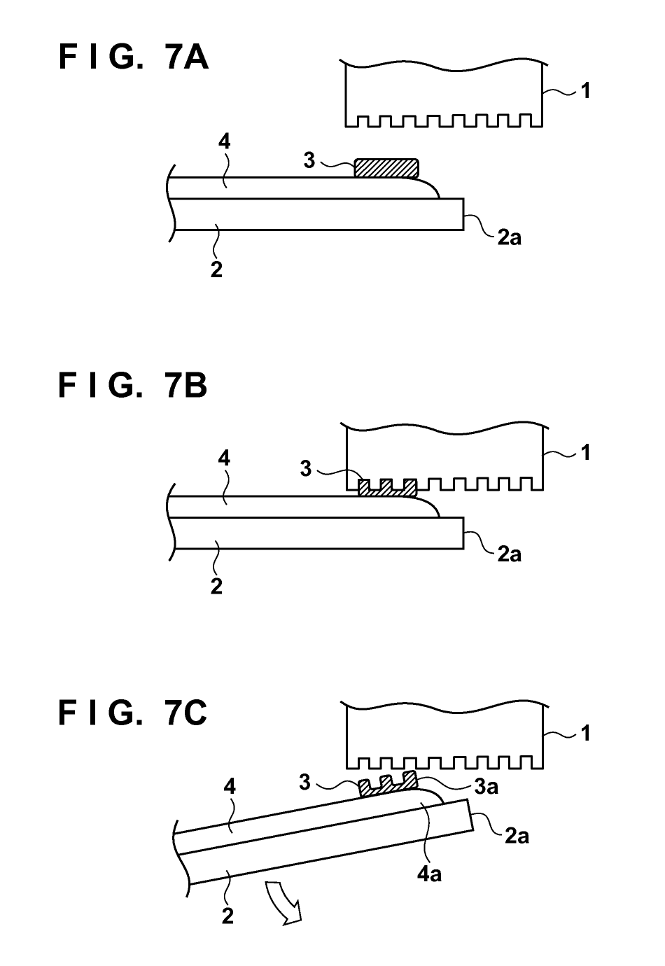

Although the mold 1 is tilted relative to the substrate 2 in releasing it in the foregoing description, the substrate 2 may be tilted relative to the mold 1, as shown in FIGS. 7A to 7C. More specifically, the resin 3 is supplied to the outer peripheral shot region SRa, and the substrate 2 is positioned so that the outer peripheral shot region SRa is set below the mold 1, as shown in FIG. 7A. Then, the mold 1 is pressed against the resin 3 on the outer peripheral shot region SRa, and the resin 3 is cured by irradiation with ultraviolet rays while the mold 1 is kept in contact with the resin 3, as shown in FIG. 7B. Lastly, the mold 1 is released from the cured resin 3 on the outer peripheral shot region SRa. At this time, the mold 1 is released while the substrate 2 is tilted relative to the pattern surface of the mold 1, that is, the Z-direction (vertical direction) through the stage 15, as shown in FIG. 7C. However, as described above, a portion from which the mold 1 is released last from the resin 3 becomes at least part of the outermost portion, in the radial direction of the substrate 2, of the resin 3 supplied to the outer peripheral shot region SRa.

Even in the release operation of the mold 1, as shown in FIG. 7C, the release operation between the resin 3 and the mold 1 is started from the inner region of the substrate 2 on the central side toward the outer region of the substrate 2 on the outer peripheral side (that is, from the inner side to the outer side of the substrate 2), in the outer peripheral shot region SRa. In other words, a force produced upon release of the mold 1 is transmitted from the inner region to the outer region of the substrate 2. The mold 1 is released last from a portion (the outermost portion in the radial direction of the substrate 2) 3a of the resin 3, which is located on an end portion 4a of the under layer 4, and the release operation of the mold 1 thus ends.

However, in releasing the mold 1 from the resin 3 on the outer peripheral shot region SRa, the substrate 2 or the substrate chuck 16 may be deformed by an actuator or a fluid pressure to curve the substrate 2, instead of tilting the substrate 2. The substrate 2 can be curved (deformed) by, for example, forming a cavity (enclosed space) between the substrate 2 and the substrate chuck 16 so as to supply and exhaust air to and from the cavity through a pipe. Also, a substrate chuck having a curved attraction surface which chucks the substrate 2 by vacuum attraction may be used. In such a case as well, a portion from which the mold 1 is released last from the resin 3 on the outer peripheral shot region SRa need only become at least part of the outermost portion, in the radial direction of the substrate 2, of the resin 3.

When a pattern is transferred to shot regions other than the outer peripheral shot regions SRa by an imprint process, and the mold 1 is released, the mold 1 may be separated from the resin 3 using a method either similar to or different from that used for the outer peripheral shot regions SRa. Also, the mold 1 can be released from the resin 3 by preferentially using a release method that prevents the resin 3 from peeling off the substrate 2 for the outer peripheral shot regions SRa, while preferentially using a release method that achieves a high speed, efficient release operation for shot regions other than the outer peripheral shot regions. The release method can be changed between shot regions indicated by hatched portions and non-hatched portions in, for example, FIG. 2C or 2D. In this way, a satisfactory imprint process can be performed by changing the release method between the outer peripheral shot regions SRa and shot regions (shot regions other than the outer peripheral shot regions) other than the outer peripheral shot regions SRa.

A method of manufacturing a device (for example, a semiconductor device or a liquid crystal display device) as an article will be described below. This manufacturing method includes a step of transferring (forming) a pattern onto a substrate (for example, a wafer, a glass plate, or a film-like substrate) using the imprint apparatus 100. The manufacturing method also includes a step of etching the substrate having the pattern transferred on it. Note that in manufacturing other articles such as pattern dot media (recording media) or optical devices, the manufacturing method includes other processing steps of processing the substrate having the pattern transferred on it, in place of an etching step. The method of manufacturing an article according to this embodiment is more advantageous in at least one of the performance, quality, productivity, and manufacturing cost of an article than the conventional method.

Although the mold or the substrate is tilted vertically in releasing the mold in this embodiment, both the mold and the substrate may be tilted vertically.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-242809 filed on Nov. 4, 2011, which is hereby incorporated by reference herein in its entirety.

What is claimed is:

1. An imprint apparatus which performs an imprint process in which an imprint material on a substrate is molded using a mold and cured, and the cured imprint material and the mold are separated from each other, thereby transferring a pattern onto the substrate, the apparatus comprising:
a holding unit configured to hold the mold;
a stage configured to hold the substrate; and
a control unit configured to control the imprint process,
wherein in the imprint process for an outer peripheral shot region among shot regions on the substrate, the control unit controls at least one of the holding unit and the stage to relatively rotate the mold and the substrate so that an outermost portion, in a radial direction of the substrate, of the imprint material supplied to the outer peripheral shot region at least partially separates from the mold last.

2. The apparatus according to claim 1, wherein in the imprint process for the outer peripheral shot region, the control unit controls at least one of the holding unit and the stage so that the imprint material and the mold separate from each other from an inner region of the substrate on a central side toward an outer region of the substrate on an outer peripheral side, in the outer peripheral shot region.

3. The apparatus according to claim 1, wherein in the imprint process for the outer peripheral shot region, the control unit controls at least one of the holding unit and the stage so that the imprint material and the mold separate from each other in the radial direction of the substrate from the center of the substrate.

4. The apparatus according to claim 1, wherein in the imprint process for the outer peripheral shot region, the control unit controls the holding unit so that the imprint material and the mold separate from each other upon vertically tilting the holding unit.

5. The apparatus according to claim 4, wherein in the imprint process for the outer peripheral shot region, the control unit tilts the holding unit to rotate the mold about a rotation axis defined by an axis located on a tangent to an outer perimeter of the substrate at an intersection between the outer perimeter of the substrate and a line which connects the center of the substrate to the center of the outer peripheral shot region.

6. The apparatus according to claim 4, wherein in the imprint process for the outer peripheral shot region, the control unit tilts the holding unit to rotate the mold about a rotation axis defined by an axis located at a distance from the center of the substrate, which is larger than a radius of the substrate.

7. The apparatus according to claim 1, wherein in the imprint process for the outer peripheral shot region, the control unit controls the stage so that the imprint material and the mold separate from each other upon vertically tilting the stage.

8. An imprint apparatus which performs an imprint process in which an imprint material on a substrate is molded using a mold and cured, and the cured imprint material and the mold are separated from each other, thereby transferring a pattern onto the substrate, the apparatus comprising:
a holding unit configured to hold the mold;
a stage configured to hold the substrate; and
a control unit configured to control the imprint process,
wherein in the imprint process for an outer peripheral shot region among shot regions on the substrate, the control unit controls at least one of the holding unit and the stage to relatively rotate the mold and the substrate so that the imprint material and the mold separate from each other from an inner region of the substrate on a central side toward an outer region of the substrate on an outer peripheral side, in the outer peripheral shot region.

9. An imprint apparatus which performs an imprint process in which an imprint material on a substrate is molded using a mold and cured, and the cured imprint material and the mold are separated from each other, thereby transferring a pattern onto the substrate, the apparatus comprising:
a holding unit configured to hold the mold;
a stage configured to hold the substrate; and
a control unit configured to control the imprint process,
wherein the control unit controls at least one of the holding unit and the stage by changing a control operation in which the mold and the imprint material supplied to shot regions are separated from each other between an outer peripheral shot region and a shot region other than the outer peripheral shot region.

10. A method of manufacturing an article, the method comprising:
a step of using an imprint apparatus to form a pattern on a substrate; and
a step of processing the substrate with the pattern,
wherein the imprint apparatus performs an imprint process in which an imprint material on the substrate is molded using a mold and cured, and the cured imprint material and the mold are separated from each other, thereby transferring a pattern onto the substrate, the apparatus includes:
a holding unit configured to hold the mold;
a stage configured to hold the substrate; and
a control unit configured to control the imprint process,
wherein in the imprint process for an outer peripheral shot region among shot regions on the substrate, the control unit controls at least one of the holding unit and the stage to relatively rotate the mold and the substrate so that the imprint material and the mold separate from each other from an inner region of the substrate on a central side toward an outer region of the substrate on an outer peripheral side, in the outer peripheral shot region.

11. A method of manufacturing an article, the method comprising:
a step of using an imprint apparatus to form a pattern on a substrate; and
a step of processing the substrate with the pattern,
wherein the imprint apparatus performs an imprint process in which an imprint material on the substrate is molded using a mold and cured, and the cured imprint material and the mold are separated from each other, thereby transferring a pattern onto the substrate, the apparatus includes:
a holding unit configured to hold the mold;
a stage configured to hold the substrate; and
a control unit configured to control the imprint process,
wherein in the imprint process for an outer peripheral shot region among shot regions on the substrate, the control unit controls at least one of the holding unit and the stage to relatively rotate the mold and the substrate so that the imprint material and the mold separate from each other from an inner region of the substrate on a central side toward an outer region of the substrate on an outer peripheral side, in the outer peripheral shot region.

12. A method of manufacturing an article, the method comprising:
a step of using an imprint apparatus to form a pattern on a substrate; and
a step of processing the substrate with the pattern,
wherein the imprint apparatus performs an imprint process in which an imprint material on the substrate is molded using a mold and cured, and the cured imprint material and the mold are separated from each other, thereby transferring a pattern onto the substrate, the apparatus includes:
a holding unit configured to hold the mold;
a stage configured to hold the substrate; and
a control unit configured to control the imprint process,
wherein the control unit controls at least one of the holding unit and the stage by changing a control operation in which the mold and the imprint material supplied to shot regions are separated from each other between an outer peripheral shot region and a shot region other than the outer peripheral shot region.
